(19) United States
(12) Patent Application Publication
(10) Pub. No.: US 2016/0374081 A1
(43) Pub. Date: Dec. 22, 2016

(54) SHORT UPLINK RESPONSES FOR DOWNLINK TRANSMISSIONS

(71) Applicant: QUALCOMM Incorporated, San Diego, CA (US)

(72) Inventors: Alfred ASTERJADHI, San Diego, CA (US); Simone MERLIN, San Diego, CA (US); George CHERIAN, San Diego, CA (US)

(21) Appl. No.: 15/184,663

(22) Filed: Jun. 16, 2016

Related U.S. Application Data
(60) Provisional application No. 62/200,605, filed on Aug. 3, 2015.
(60) Provisional application No. 62/182,400, filed on Jun. 19, 2015.

(51) Int. Cl. H04W 72/04

(52) U.S. Cl. CPC H04W 72/0446; H04W 72/0406

(57) ABSTRACT

Certain aspects of the present disclosure provide an apparatus for wireless communications. The apparatus generally includes a processing system configured to generate a frame based on a compressed response frame format.

### CLAIM OF PRIORITY UNDER 35 U.S.C. §119

The present application for patent claims benefit of U.S. Provisional Patent Application Ser. No. 62/182,400 (Attorney Docket number 154091USL), filed Jun. 19, 2015, and 62/200,605 (Attorney Docket number 154091USL02), filed Aug. 3, 2015, each assigned to the assignee hereof and hereby expressly incorporated by reference herein.

### BACKGROUND

Field of the Disclosure

Certain aspects of the present disclosure generally relate to wireless communications and, more particularly, to medium access control (MAC) header compression, for example, for high efficiency wireless (HEW) frames.

Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

A method for wireless communications by a station. The method generally includes receiving a frame, selecting, from a plurality of possible frame formats, a compressed frame format for a response frame to be transmitted in response to the frame, the compressed frame format lacking one or more fields defined by one or more of the other possible formats, generating the response frame based on the compressed frame format, and outputting the response frame for transmission. In certain embodiments the response frame comprises a control frame.

A method for wireless communications by a station. The method generally includes outputting a frame for transmission, obtaining a response frame transmitted from at least one recipient in response to the MU-frame, the response frame having a compressed frame format, selected from a plurality of possible frame formats, the compressed frame format lacking one or more fields defined by one or more of the other possible formats, and processing the response frame based on the compressed frame format.

Aspects of the present disclosure also provide various apparatuses, computer readable mediums, and products capable of performing the operations described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example wireless communications network, in accordance with certain aspects of the present disclosure.

FIG. 2 is a block diagram of an example access point (AP) and user terminals, in accordance with certain aspects of the present disclosure.

FIG. 3 is a block diagram of an example wireless device, in accordance with certain aspects of the present disclosure.

FIG. 4 illustrates an example uplink (UL) downlink (DL) multiple user (MU) frame exchange.

FIG. 5 illustrates an example protocol version 0 medium access control (MAC) protocol data unit (MPDU), in accordance with certain aspects of the present disclosure.

FIG. 6 illustrates an example protocol version 1 MPDU, in accordance with certain aspects of the present disclosure.

FIG. 7 illustrates an example UL/DL MU frame exchange, in accordance with certain aspects of the present disclosure.

FIG. 8 illustrates an example response frame with trigger information, in accordance with certain aspects of the present disclosure.

FIG. 8A illustrates an example HE Response frame format, in accordance with certain aspects of the present disclosure.

FIG. 9 illustrates an example frame exchange, in accordance with certain aspects of the present disclosure.

FIG. 10 is a flow diagram of example operations for wireless communications, in accordance with certain aspects of the present disclosure.

FIG. 10A illustrates example means capable of performing the operations shown in FIG. 10.

FIG. 11 is a flow diagram of example operations for wireless communications, in accordance with certain aspects of the present disclosure.

FIG. 11A illustrates example means capable of performing the operations shown in FIG. 11.

FIG. 12 illustrates example fields of a control field, in accordance with certain aspects of the present disclosure.

FIG. 13 illustrates an example frame exchange, in accordance with certain aspects of the present disclosure.

FIGS. 14A and 14B illustrate example response frames for acknowledging DL transmissions, in accordance with certain aspects of the present disclosure.

FIG. 15 illustrates example performance achievable using compressed response frames, in accordance with certain aspects of the present disclosure.

FIG. 16 illustrates an example frame exchange, in accordance with certain aspects of the present disclosure.

FIG. 17 illustrates example fields of a control field, in accordance with certain aspects of the present disclosure.

FIG. 18 illustrates example contents of an NDP frame, in accordance with certain aspects of the present disclosure.

FIG. 19 illustrates example performance achievable using compressed response frames, in accordance with certain aspects of the present disclosure.

FIG. 20 illustrates example fields of a control field, in accordance with certain aspects of the present disclosure.

FIG. 21 illustrates example performance achievable using compressed response frames, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects of the present disclosure generally relate to physical (PHY) layer medium access control (MAC) layer signaling, such as providing an immediate response allocation with indication in 11ax PHY header. According to certain aspects, a station may send a frame (e.g., an MPDU) based on a compressed frame format (e.g., a short frame) that includes an additional field (e.g., an HE Control field) with control information. According to certain aspects, stations may send a frame having a first one or more bits (e.g., in Bit 1 of the MPDU delimiter) indicating whether the frame has a compressed format and a second one or more bits (e.g., 2 MSBs of the MPDU Length field of the MPDU delimiter) indicating which of one or more fields are absent if the frame has a compressed format.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting and the scope of the disclosure is being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT is a wireless node. Such wireless node may provide, for example, connectivity for or to a network (e.g., a wide area network such as the Internet or a cellular network) via a wired or wireless communication link.

### An Example Wireless Communication System

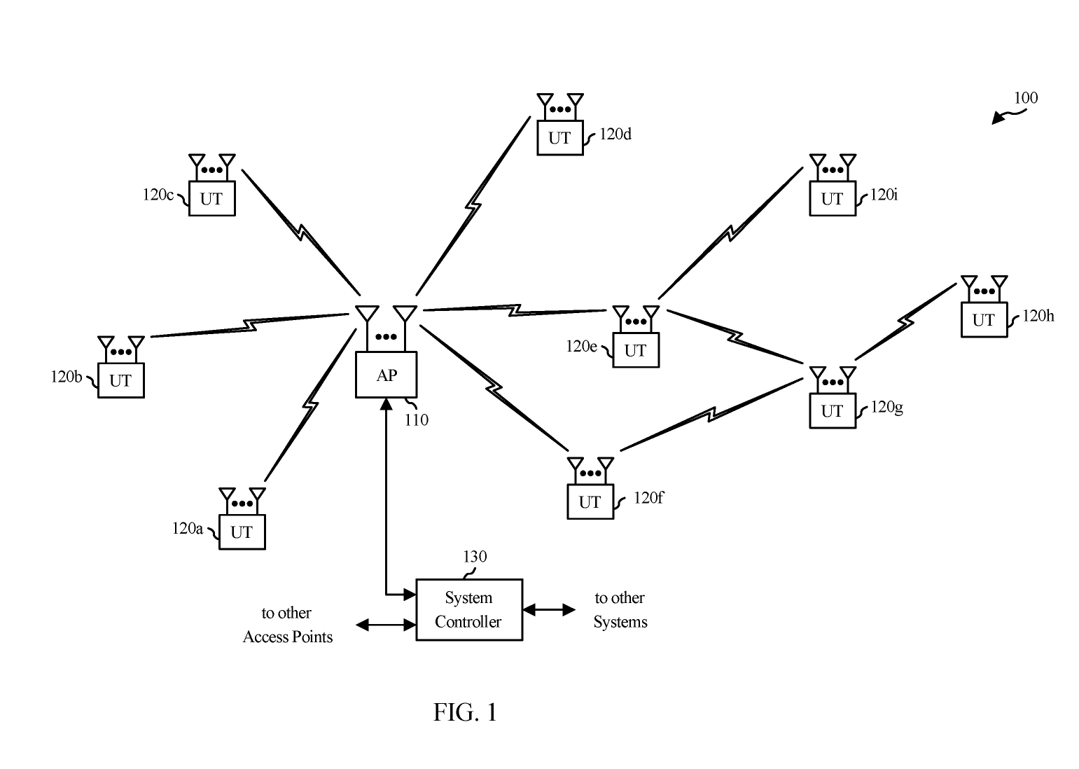

FIG. 1 illustrates a system 100 in which aspects of the disclosure may be performed. For example, the access point 110 may send user terminals 120 a frame (e.g., an MPDU) based on a compressed frame format (e.g., a short frame) that and includes control information in at least one field (e.g., an HE Control field). The frame may be any type of frame, such as a data frame, control frame, management frame, or extended frame. In another example, the access point 110 may send user terminals 120 a frame having a first one or more bits (e.g., in the MPDU delimiter) indicating whether the frame has a compressed format and a second one or more bits (e.g., 2 MSBs of the MPDU Length field of the MPDU delimiter) indicating which of one or more fields are absent if the frame has a compressed format. In another example, the one or more bits can be included in the frame itself. In certain embodiments the one or more bits are located in the PHY header (e.g., in the SIG-A, SIG-B or SIG-C field of the PPDU that carries the frame). In another embodiment a frame that immediately precedes this frame may contain these one or more bits. In certain embodiments the immediately preceding frame is transmitted by the peer STA (e.g., the intended receiver of this frame).

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

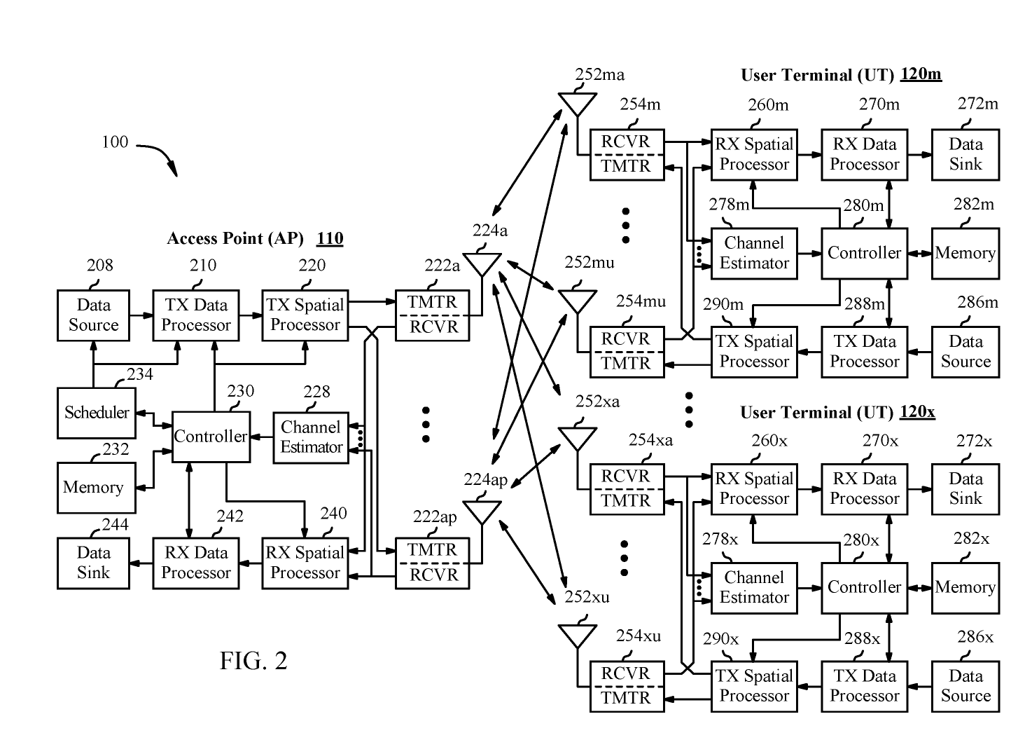

FIG. 2 illustrates a block diagram of a system 100 in which aspects of the present disclosure may be performed. For example, the access point 110 may send user terminals 120 a frame (e.g., an MPDU) based on a compressed frame format (e.g., a short frame) that and includes control information in at least one field (e.g., an HE Control field). As noted above, the frame may be any type of frame, such as a data frame, control frame, management frame, or extended frame. In another example, the access point 110 may send user terminals 120 a frame having a first one or more bits (e.g., in the MPDU delimiter) indicating whether the frame has a compressed format and a second one or more bits (e.g., 2 MSBs of the MPDU Length field of the MPDU delimiter) indicating which of one or more fields are absent if the frame has a compressed format. In another example, the one or more bits can be included in the frame itself. As noted above, the one or more bits may be located in the PHY header (e.g., in the SIG-A, SIG-B or SIG-C field) of the PPDU that carries the frame, in a frame that immediately precedes this frame, which may be transmitted by a peer STA (e.g., the intended receiver of this frame).

The system 100 may be, for example, a MIMO system with access point 110 and two user terminals 120m and 120x. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 120, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

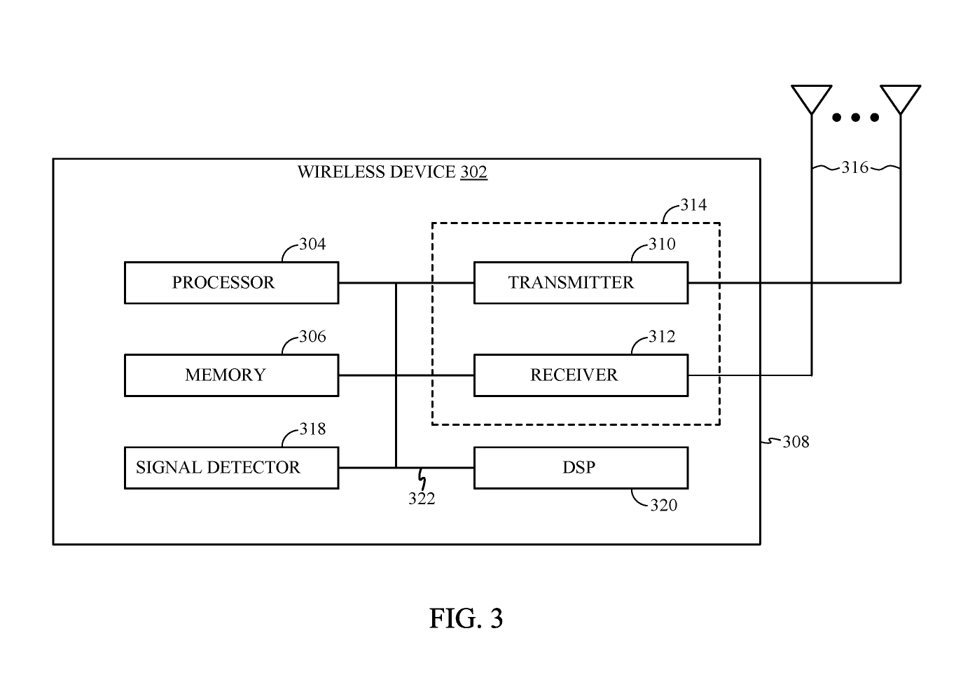

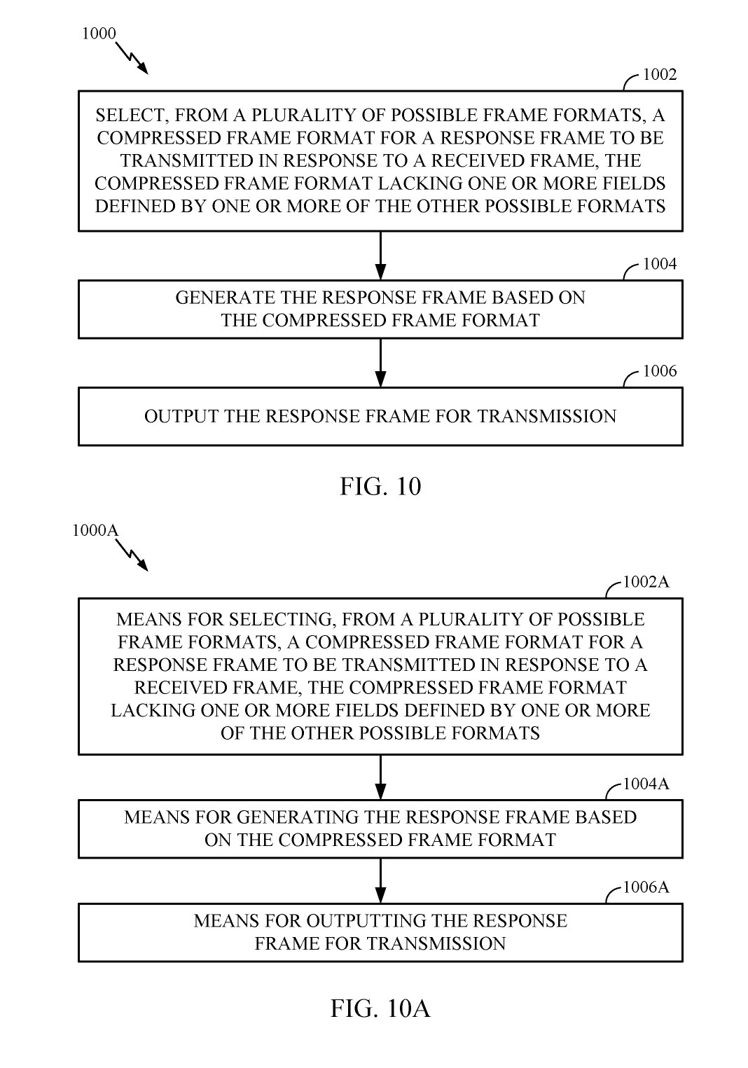

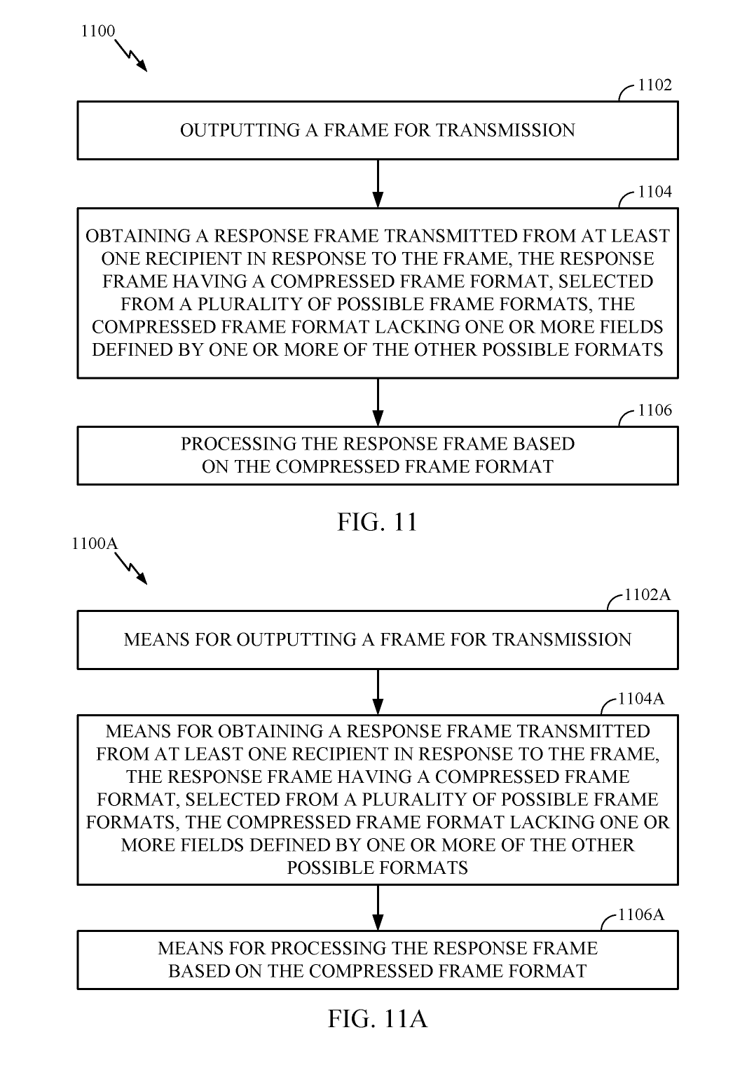

FIG. 3 illustrates various components that may be utilized in a wireless device 302 that may be employed within the MIMO system 100. The wireless device 302 is an example of a device that may be configured to implement the various methods described herein. For example, the wireless device may implement operations 1000 and 1100 illustrated in FIGS. 10 and 11, respectively. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example Mac Header Compression

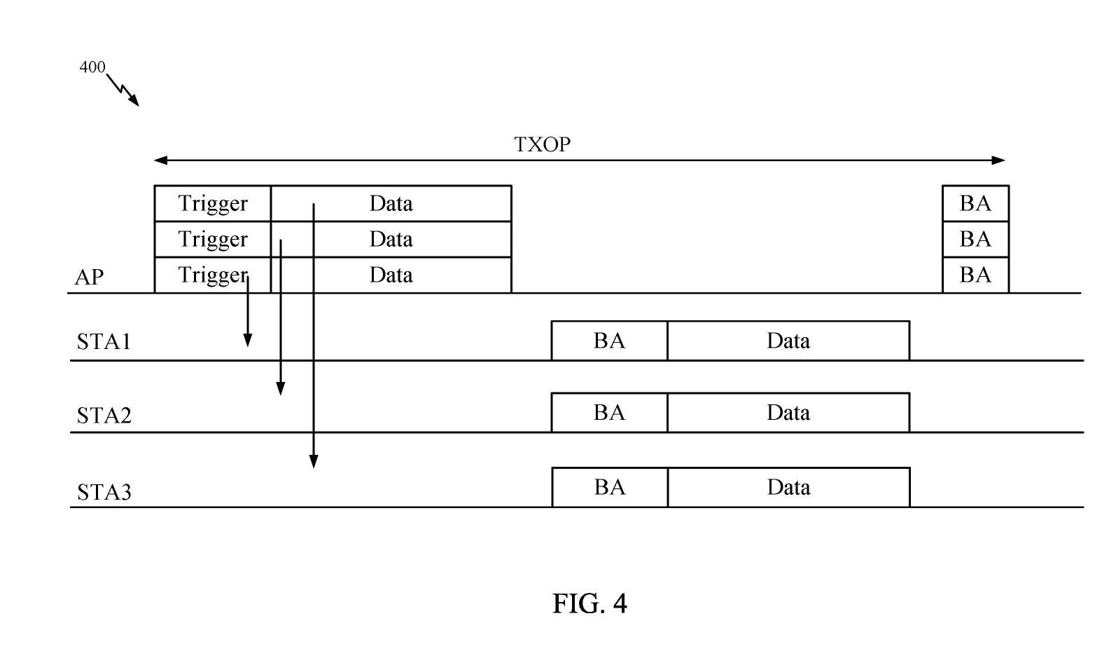

For multiple user (MU) operations, low data rates (e.g., 750 kbps) may be used. While MU transmissions are described herein as examples, the techniques presented herein apply more generally to SU transmissions, which may be considered a sub-case of MU transmissions (e.g., where the number of recipients is 1). FIG. 4 illustrates an example uplink (UL) downlink (DL) frame exchange 400 showing MU operations.

As shown in FIG. 4, an access point (AP) may transmit a trigger frame aggregated with data (e.g., as part of an aggregated medium access control (MAC) protocol data unit (A-MPDU) addressed to the same STA) on the downlink to a number of stations (STAs) STA1, STA2, and STA3, etc. The downlink frame may solicit an immediate response (e.g., a block acknowledgment (BA), acknowledgement (ACK), etc.) from one or more of the stations and/or schedule the stations for sending uplink data. For example, the trigger frame may include control information such as the UL resource allocation, modulation coding scheme (MCS), etc. On the uplink, the stations may use the allocated resources to each send, for example, BA frames aggregated with data, wherein the BA frames acknowledge the data received from the AP. The AP may then respond with BA for each STA on the downlink to acknowledge the UL data. As shown in FIG. 4, in both the uplink and downlink directions, In other words, a control frame (e.g., a trigger frame, BA frame, ACK frame, etc.) may be aggregated with one or more frames and are transmitted as an A-MPDU.

MAC signaling overhead may increase with low data rate and/or reduced air times. MAC signaling overhead may also increase with an increased number MAC frame exchanges (signaling frequency), such as by increasing the number of MPDUs exchanged during air time and/or increasing MAC signaling within an MPDU. Thus, for MU operations, MAC signaling overhead may be increased since the AP may be signaling multiple STAs simultaneously.

Accordingly, techniques for reducing MAC signaling overhead are desirable. According to certain aspects of the present disclosure, techniques are provided herein for removing redundant/unnecessary overhead due to protocol signaling for short packet at the physical layer protocol data unit (PPDU), MPDU, and A-MPDU level. Aspects of the present disclosure provide for PHY signaling in a PPDU, decoupled from MAC signaling, which allocates PHY resources for an immediate response and carrying a MAC payload in the immediate response PHY resources.

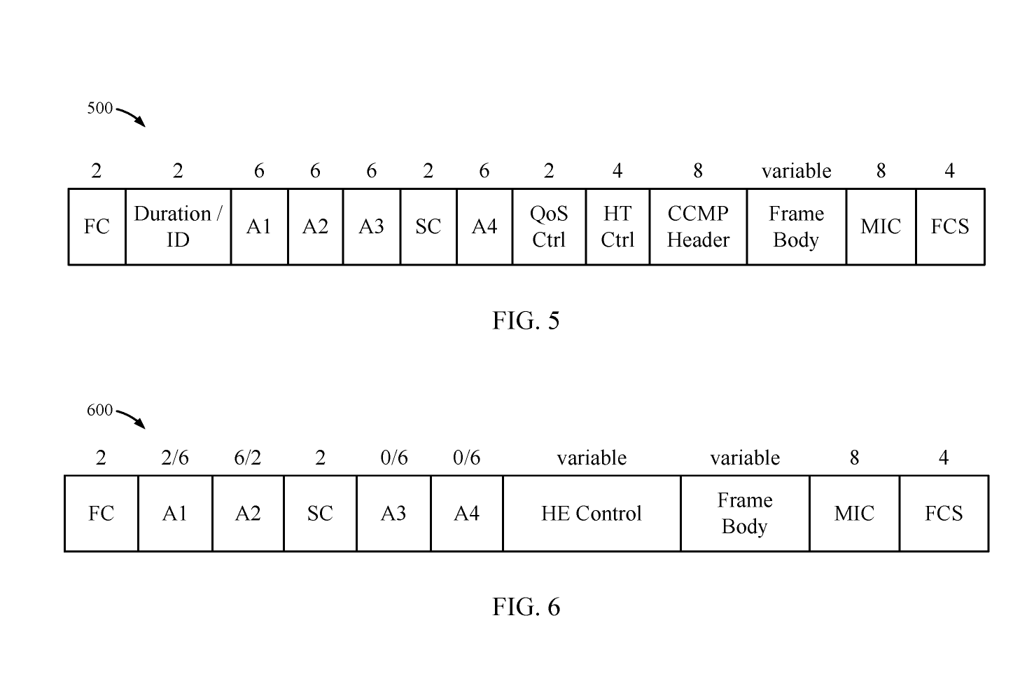

According to certain aspects, header compression may be performed to reduce signaling overhead at the MPDU level. FIG. 5 illustrates an example protocol version 0 MPDU frame format 500, in accordance with certain aspects of the present disclosure. FIG. 6 illustrates an example protocol version 1 (short frame) MPDU, in accordance with certain aspects of the present disclosure. According to certain aspects, PV1 frame format may have less overhead than the PV0 frame format. According to certain aspects, PV1 MPDUs may have a minimum MAC overhead of 16 Bytes (or 24 Bytes with security) instead of a minimum MAC overhead of 30 Bytes (46 Bytes with security) of a PV0 MPDU. Thus, for PV1 frames, per-MPDU MAC overhead may be reduced by 16 Bytes (or 22 Bytes with security). An additional control field (e.g., a high efficiency (HE) Control field) may be added to the PV0 or PV1 frame structure in order to provide certain control information. For example, although not shown in FIG. 5, the HT field may be used as the HE Control field and may be of variable length so that to contain the various control information provided by control frames.

As shown in the example frame format 600 of FIG. 6, a variable length HE Control field may be added to the PV1 frame format. According to certain aspects, a payload field may be defined and may be added to control frames in order to carry the payload content of a frame or quality of service (QoS) frame. According to certain aspects the HE control field can be added to any frame (any value of the PV). According to certain aspects, overhead reduction may be performed at the A-MPDU level.

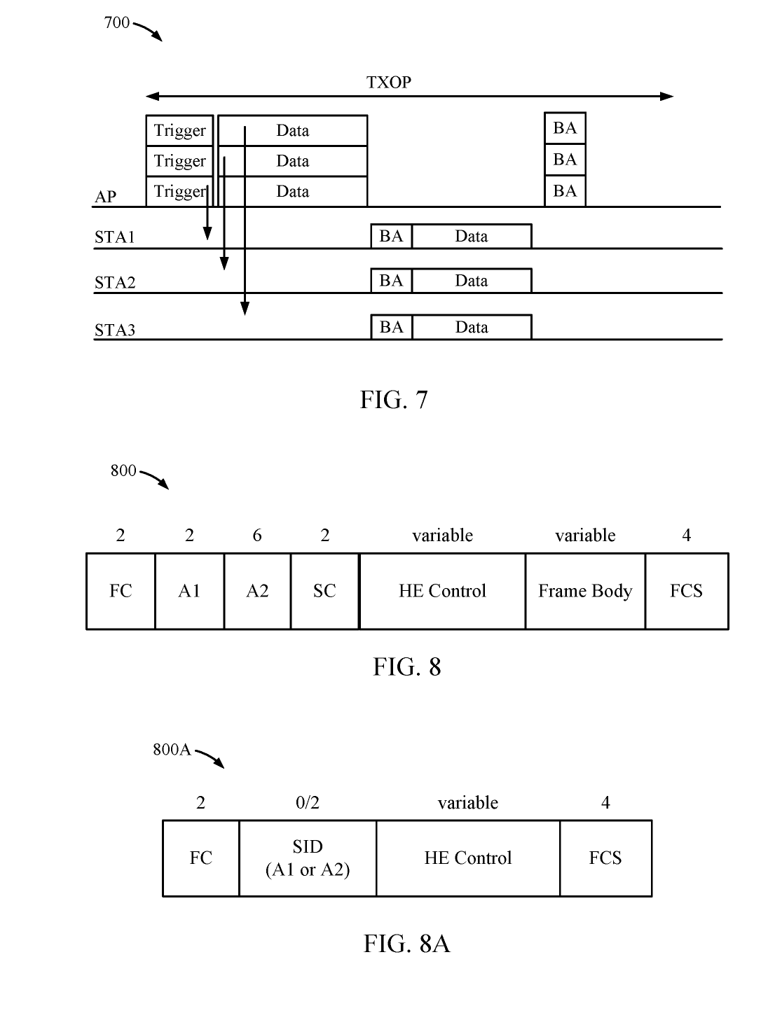

FIG. 7 illustrates an example MU frame exchange 700, in accordance with certain aspects of the present disclosure. As shown in FIG. 7, on the DL, the AP may transmit a frame with trigger information and data to stations STA1, STA2, STA3. Generally, if a control frame is appended in an A-MPDU this happens to be always the first MPDU.

According to certain aspects, the AP may transmit a wrapped version of the first two MPDUs. Data and Control wrapping may be sufficient to carry the control information, rather than sending the response frame and the frame as two independent MPDUs. According to certain aspects, the control information (e.g., trigger info) may be wrapped in the Frame as a Data+Control frame (e.g., Data+Trigger frame).

As shown in the example frame format 800 of FIG. 8, the control information may be included in a field (e.g., the HE Control field) that is contained in a compressed Frame (e.g., a PV1 with some fields absent).

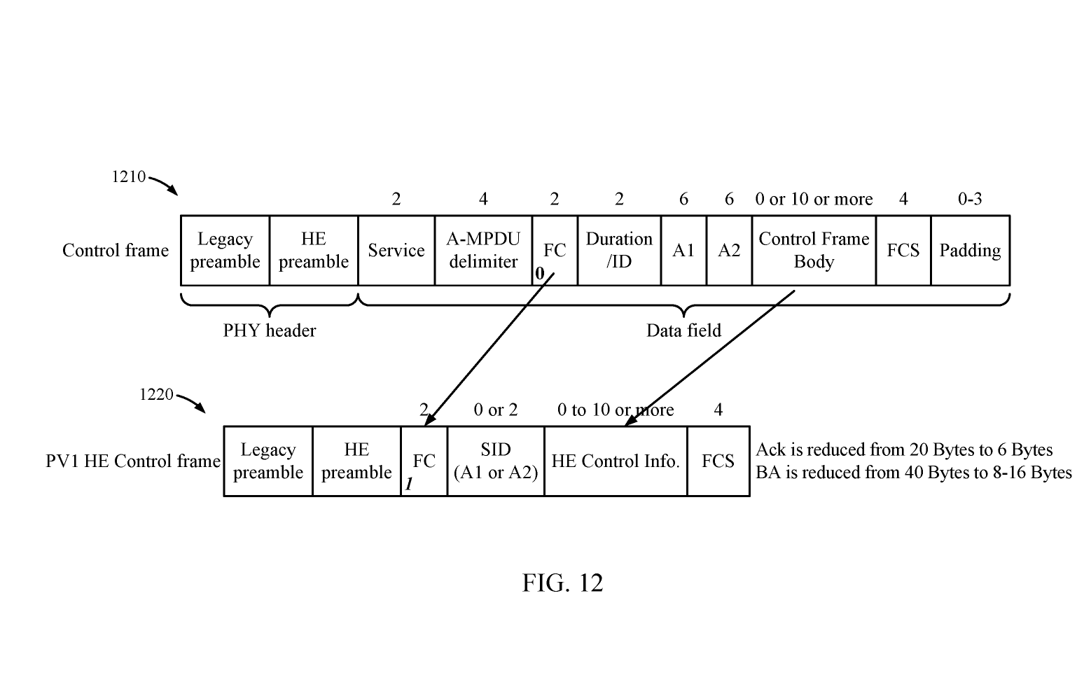

In certain aspects, the HE Control field that is included in the frame (PV0, PV1 or anything else) as described above may include the Frame Control field of the control frame the control information of which the HE Control field is carrying (see FIG. 12). As an example, the Frame Control field that is contained in the HE Control field may indicate that the information contained is that of a BlockAck frame (i.e., the type field of the frame control field indicates a control frame and the subtype field indicates a BlockAck frame). As a result the remaining portion of the HE Control field may contain the control information that is carried by this type of frame for example the BlockAck Control field, the Starting Sequence Control field, and the BlockAck Bitmap field (i.e., when the HE Control field contains BlockAck control information it may consist of one or more of the following fields (Frame Control, Block Ack Control, Starting Sequence Control, Block Ack Bitmap). In general, the HE Control field may carry the control information of any type of control frame (excluding the Duration, A1, A2 and FCS fields of the Control frame). In certain aspects, the HE Control field may carry certain information elements that would have been included in management frames, i.e., it may act as a carrier of management information. One or more fields of the HE control field may indicate the different combinations.

According to certain aspects, the control field may contain the frame control (FC) field of the response frame and may contain additional information depending on the FC field subtype value. For example, if the FC field subtype value indicates a trigger, the control field may also contain the STA info field to indicate which STAs are the intended recipients and requested to respond. Alternatively, if the FC field subtype value indicates BlockAck, the control field may also include the BA Control field, Starting Sequence Control (SSC) field, and BlockAck Bitmap field. Thus, as shown in FIG. 7, the STAs may respond with a wrapped frame which can contain a Data+BA, upon reception of which the AP may then respond with BA. For the Ack frame, its presence is not needed because the frame itself would indicate successful acknowledgement. In another implementation, the presence of the Frame Control field may be sufficient to identify the Ack frame. According to certain aspects, the Frame Control field may be reduced to 1 Octet in length and may contain only part of its subfields (e.g., not contain one or more of the protocol version field, type field, from DS (Distribution System), To DS, more fragments, retry, or the like, as these fields are generally set to predefined values in Response frames).

According to certain aspects, the HE Control field may carry certain information elements that would have been included in management frames, i.e., it may act as a carrier of management information. One or more fields of the HE control field may indicate the different combinations.

According to certain aspects, the HE control field may include the information of a control frame or management frame, however, certain fields of the control or management frame may be absent, for example, such as the A1 field, the A2 field, the Duration/ID field, and/or the FCS field. According to certain aspects, a newly defined frame may carry one or more portions of the HE Control field. According to certain aspects, the newly defined frame may be a PV0 frame or a PV1 frame. The newly defined frame may carry portions of the HE Control field and may be a frame of any type, such as a control frame, a management frame, a data frame, or an extended frame (i.e., the type subfield of the frame control field of the newly defined frame may be set to any value). In an example implementation, the control frame or management frame fields absent in the newly defined frame may include at least one of the following fields: Duration field, A1 field, A2 field; however, the HE Control field may be present in the newly defined frame. According to certain aspects, the newly defined frame may be a PV1 HE Control frame. Alternatively, the newly defined frame may be a PV0 HE Control frame. In another example implementation, the newly defined frame may contain either of the A1 or A2 fields that contains at least a portion of the AID of the transmitting STA or receiving STA as specified in the Frame Control field of the newly defined frame. According to certain aspects, the A1 or A2 fields may contain an identifier copied from the immediately previously received frame that elicited the current HE control frame. According to certain aspects, the presence of the A1 or A2 field may be signaled by setting one or more subfields of the Frame Control field of newly defined frame to a non-zero value.

FIG. 8A illustrates an example HE Control frame format 800A, in accordance with certain aspects of the present disclosure. As discussed above, the HE Control frame format may be PV0 or PV1 frame format. According to certain aspects, the HE Control frame may be carried in an A-MPDU along with PV1 MPDUs and/or PV0 MPDUs. According to certain aspects, more than one HE Control frame may be carried in the A-MPDU, each HE Control frame being addressed to one or more STAs, for example, when the A-MPDU is addressed to one or more STAs. The A-MPDU frame may be transmitted as a single user (SU) transmission or as a multi user (MU) transmission. The transmissions may be either DL or UL and may use either OFDMA or MIMO.

According to certain aspects, applying the above techniques, for two MPDUs, wrapped control information and data may be sent to the multiple STAs without using the A-MPDU format. Thus, the A-MPDU format overhead (greater than 8 bytes) may be removed as well as much of the MAC overhead of a response frame (e.g., 18 Bytes from Trigger (Duration (2B), A1 (6B), A2 (6B), FCS (4))).

In certain cases, it may be beneficial to aggregate multiple short packets in an A-MPDU (more than two MPDUs), for example, to exploit robustness provided by the frame check sequence (FCS) field or to aggregate fragments of an MPDU, etc.

According to certain aspects, indicators in the MPDU delimiter may be used to indicate presence or absence of one or more fields in each of the MPDU that follow the MPDU delimiter.

### Example Short Responses for MU

As noted above, certain response frames (e.g., PV1 HE Control frames) may be used to reduce MAC overhead in various scenarios. In certain scenarios, however, further overhead reduction may be desirable.

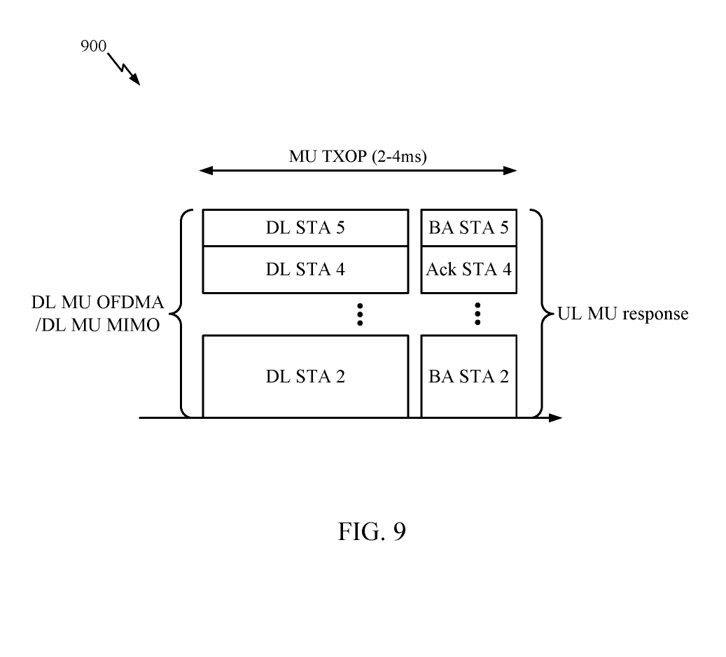

For example, in MU transmit opportunities where an AP and STAs exchange MU DL Data and MU UL ACKs, such as in the example exchange 900 shown in FIG. 9, the duration of the UL MU response opportunity may need to be equal to the longest UL response across all STAs to ensure all responses can be received. In some scenarios, a BA from one or more of the STAs may be significantly long (e.g., lasting as long as ˜0.82 ms for a VHT Single MPDU@416 Kbps, with a 2.5 MHz resource unit and a MCS10 modulation and coding scheme). Similar considerations may apply when the responses are in the DL (sent from an AP) for UL MU transmissions. In general overhead reductions may be particularly desirable for any exchange that requires a response which, due to limitations in rate or bandwidth, would require a considerable amount of time.

Aspects of the present disclosure may allow for reductions in overhead that, in turn, may help reduce the duration of response transmissions and improve overall performance. In some cases, a STA may instruct an intended receiver to carry the response frame in a compressed format. As used herein, the term compressed format refers to any frame format that has omitted one or more fields relative to a non-compressed (or less-compressed) frame format.

For example, the STA may be an AP that instructs an intended receiver to use a PV1 HE Control frame format for a control response frame, rather than carrying the control response frame in an A-MPDU format. As such, the control response frame may lack certain fields that would otherwise be present in the PPDU, such as a one or more fields of the PHY header (e.g., the Service field, selected LTFs, STFs, or SIG fields that may not be required (e.g., L-STF, L-LTF, L-SIG)). The response frame may additionally or alternatively lack one or more fields of the A-MPDU format (e.g., the MPDU delimiter, Padding), one or more fields of the MPDU format (e.g., the Duration/ID, A1, A2, and eventually the FCS field), or a combination of both.

FIG. 10 is a flow diagram of example operations 1000 for wireless communications, in accordance with certain aspects of the present disclosure. The operations 1000 may be performed, for example, a station after receiving an MU frame (e.g., AP 110 or user terminal 120).

The operations 1000 begin, at 1002, by selecting, from a plurality of possible frame formats, a compressed frame format for a response frame to be transmitted in response to the MU frame, the compressed frame format lacking one or more fields defined by one or more of the other possible formats. At 1004, the STA may generate the response frame based on the compressed frame format and, at 1006, output the frame for transmission. The selection may, for example, be based on a value of an aggregation bit provided in the frame and/or may be indicated by the value of the aggregation bit provided in the response frame.

FIG. 11 is a flow diagram of example operations 1100 for wireless communications, in accordance with certain aspects of the present disclosure. The operations 1100 may be performed, for example, a station (e.g., AP 110 or user terminal 120). In other words, the operations 1100 may be AP-side operations that are complementary to the station-side operations shown in FIG. 10.

The operations 1100 begin, at 1102, by outputting a multi-user (MU) frame for transmission. At 1104, the AP obtains a response frame transmitted from at least one recipient in response to the MU-frame, the response frame having a compressed frame format, selected from a plurality of possible frame formats, the compressed frame format lacking one or more fields defined by one or more of the other possible formats. At 1106, the AP processes the response frame based on the compressed frame format.

In some cases, the use of a compressed response frame format may be indicated by setting a bit (e.g., which may be referred to as an aggregation bit) in the eliciting frame (e.g., by setting such a bit to 0 to indicate no compression). As will be described in greater detail below, in some cases, the STA may use a variable length BlockAck Bitmap field for BA frames carried in the compressed frame format to further reduce overhead.

FIG. 12 illustrates two example formats of a response frame. The upper response frame format 1210 represents an example of a normal (non-compressed) response frame format, while the lower response frame format 1220 represents an example of a compressed response frame format. As illustrated, the example compressed response frame format 1220 lacks a number of fields, such as the Service field, the A-MPDU delimiter, Duration field and padding bits. In addition, A1 and A2 fields may be combined (compressed) into a single short Identifier (SID).

In certain embodiments some portions of fields in the eliciting frame (frame eliciting the response) may indicate which transmit parameters and which of the fields to include in the response frame.

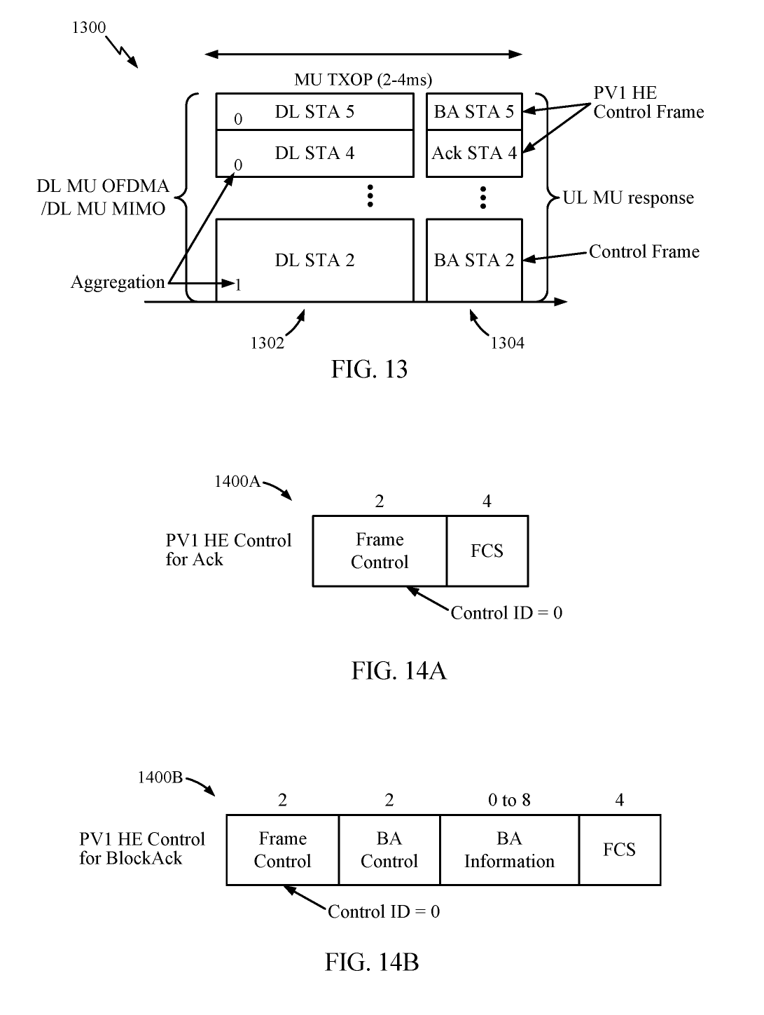

FIG. 13 illustrates an example frame exchange 1300, in accordance with certain aspects of the present disclosure. As illustrated, the AP may indicate the type of response frame it wants to elicit in the DL MU PPDU 1302 itself via an aggregation (or compression) bit. For example, the AP may set the Aggregation bit to 0 to indicate that the response is to be carried in a compressed response frame 1304.

In certain embodiments this response frame is a PV1 HE Control frame. Otherwise, the AP may set the aggregation bit to 1 to indicate that the response is to be carried in an A-MPDU format (VHT Single MPDU). Of course, the particular values shown are examples only and an alternate (opposite) convention may be used. In certain embodiments, the Aggregation bit may be carried in a service (SVC) field of the PPDU itself (e.g., in bit 7 of the SVC field).

In certain embodiments the Aggregation bit can be carried in the response frame itself (e.g., in the SIG-B or SIG-C field). The intended receiver of a DL MU PPDU with Aggregation equal to 0 may, in turn, responds with a PV1 HE Control frame that carries Ack/BA information depending on what is being solicited (e.g., the response frame acknowledges via an ACK or Block Ack based on an ACK policy in the soliciting frame).

In some cases, a short identifier (SID) field may not be present in the PV1 HE Control frame. Even though not transmitted, the SID, identifier of the eliciting frame (same as STACK frames), may used for calculating the FCS of the response frame. The Control ID subfield of the first HE Control field may be carried (e.g., in the second byte of) the Frame Control field of the frame. In certain embodiments the Control ID subfield is carried in B8-B12 of the Frame Control field. In some cases, the Control ID subfield may be set to 0 to indicate a PV1 HE Control frame carrying an Ack frame and may be set to 1 when carrying a BlockAck frame. However these are only exemplary values and any mapping can be used for such purpose.

In certain embodiments the compressed response frame may carry more than one HE control field. This may be done in an effort to more efficiently utilize all of the (time and frequency) resource allocated to transmit this response frame. For example, the AP may allocate 300 us of time for the response but one HE Control field carried in the frame may not be enough to fill the 300 us allocation. In this embodiment the STA may aggregate multiple HE control fields in order to fill the allocation, wherein an indication (e.g., EOH bit set to 0) in the HE control field may be used to signal the presence of a following HE Control field (until an EOH bit set to 1 signals the last HE control field).

In some cases, the FCS of the response frame may be generated accounting for the value contained in the SID field (that is then omitted from the frame prior to transmission). The SID field may be based on information in the eliciting frame. For example, the SID field of the response frame may be generated based on a function (e.g., concatenation) of 0 or more bits of the Scrambler Initialization value, prior to descrambling, of the eliciting frame, and 1 or more bits of the FCS of the eliciting frame.

FIGS. 14A and 14B illustrate example response frames for acknowledging DL transmissions, in accordance with certain aspects of the present disclosure. As illustrated in 1400A, in a PV1 HE Control frame carrying Ack, the HE Control Information field may not be present, as no other information may be needed for signaling an Ack. In some cases, a Control ID field may be part of the HE Control Information field. In some cases, as illustrated in 1400B, the Control ID field may be carried in the Frame Control field of the frame (e.g., in B8 to B12 as a specific example of a 5-bit field).

In a PV1 HE Control frame carrying BlockAck, the HE Control Information field may carry a BA Control and BA Information field (same as the normal BA frames). In such cases, the BA Control may indicate the BA Bitmap Size (e.g., 0, 2, 4, 6, 8 or more) bitmap sizes may be signaled in a Fragment Number field using currently reserved values). In general, this signaling of the BA Bitmap Size may be applicable to any type of BlockAck frame, independently of whether it is compressed or not.

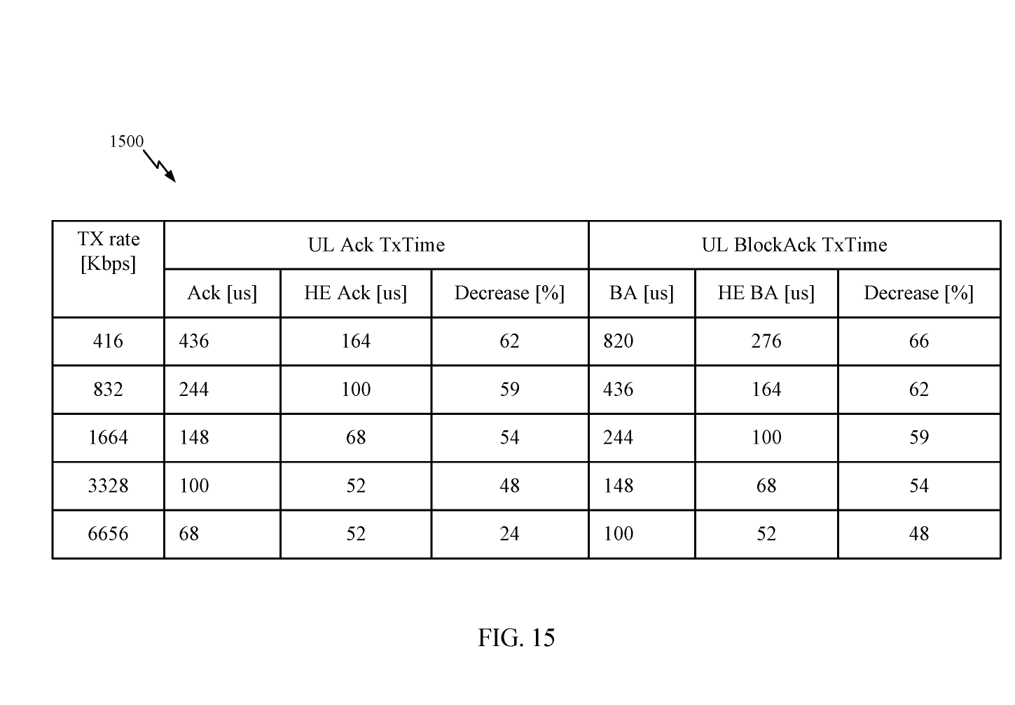

FIG. 15 illustrates a table 1500 demonstrating example performance achievable using compressed response frames, in accordance with certain aspects of the present disclosure.

As illustrated in FIG. 15, use of the compressed response frame format proposed herein may help reduce the overhead of control responses in UL OFDMA by up to 63% in the case of an Ack frame (e.g., by reducing MAC payload by 14 Bytes) and up to 66% in the case of a BA frame (e.g., by reducing MAC payload by 28 Bytes), assuming 4 Byte BA Bitmap. As described herein, using compressed response frames (e.g., PV1 HE Control frames) for acknowledging DL MU frames may significantly reduce the overhead of control responses. The use of shorter control responses may also be beneficial, as their use may lead to less interference to neighbor overlapping basic service sets (OBSSs).

As described above, in some cases, the AP may to indicate the format to be used for delivering CTRL responses, for example, via an aggregation bit set to 0 to indicate that a PV1 HE Control frame is to be used (not in A-MPDU). In some cases, the Aggregation bit can be added to the MAC header of the eliciting PPDU (e.g., in an HE Control field of the eliciting PPDU). As noted above, the Aggregation bit may also be carried in a SVC field (in a PLCP header) of the PPDU itself (e.g., bit 7).

That the PV1 HE Control frame may generally be referred to as an HE Control frame. If a protocol version field is present in the FC field then it may be set to any value. In some cases, the value of the Aggregation bit may determine the format of all frames that are currently being exchanged between the two STAs during the TXOP (i.e., not only for the UL response). In some cases, the Aggregation bit may be carried in the SIG field (e.g., SIG-B or SIG-C field) of the frame to indicate the MPDU format of the frame itself (e.g., allowing the responding station to indicate the format it has selected for the response frame). In certain embodiments, the aggregation bit in the first frame exchanged in the TXOP determines the format to be used during the duration of the TXOP.

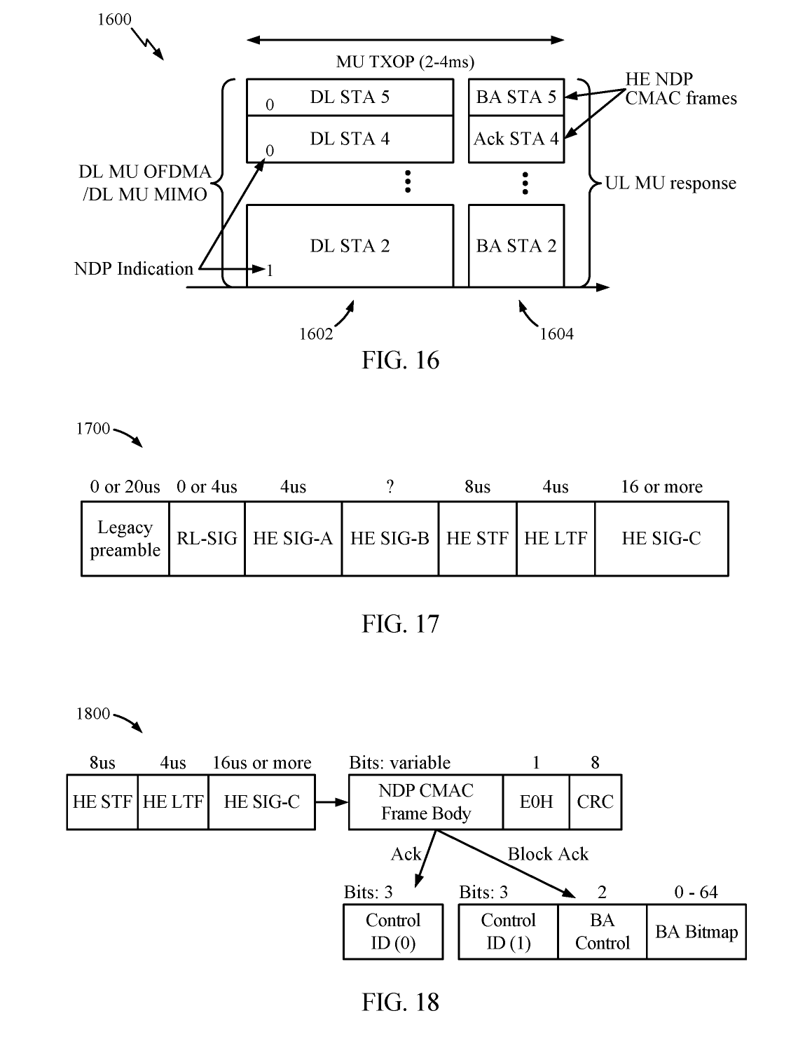

As illustrated in FIG. 16, in some cases, null data packet (NDP) frame formats may be used for response frames 1604. As in the examples described above, the AP may indicate the type of response frame it wants to elicit in the DL MU PPDU frames 1602. In this example, an Aggregation (or NDP_Indication) bit may be set to 0 to indicate that the response is to be carried in an HE NDP CMAC frame. Otherwise, the bit may be set to 1 to indicate that the response is to be carried in an A-MPDU format (VHT Single MPDU). In turn, the intended receiver of a DL MU PPDU with Aggregation/NDP Indication set to 0 may respond with an HE NDP CMAC frame that carries Ack/BA information depending on what is solicited (the Ack/BA Information may be contained in the HE Control field which is contained in the HE SIG-C field).

FIG. 17 illustrates example fields of a response sent using an NDP frame format 1700, in accordance with certain aspects of the present disclosure. In the illustration, fields that are shown with cross-hatching (e.g., legacy preamble, RL-SIG, HE SIG-A, and HE-SIG-B) may not be included in the response. As noted above, Ack/BA Information may be contained in the HE Control field (which is contained in the HE SIG-C field).

FIG. 18 illustrates example contents of an NDP frame format 1800, in accordance with certain aspects of the present disclosure. Various cases of the HE control field are considered. For an NDP Ack frame, there may be no need of an identifier because of the centralized scheduling of the response minimizes the probability of false alarm. In this case, the CRC may be calculated assuming the SID field is present in the field (even though the SID field is omitted in the response frame itself). For a BlockAck frame, the BA control field contains the SSN and the Bitmap Size (e.g., as 4 bits to indicate 0, 8, . . . , 64 bits for the BA Bitmap).

In some cases, a variable number of fields (e.g., HE control fields) may be included in the response frame. In such cases, an indicator (e.g., an “End of HE Control Field” or “EOH” field) after each HE control field may indicate if other HE Control fields follow the current field. This approach can be used for padding so that the responses end at the specified duration. In some cases, an EOH field may also be carried in the Frame Control field as well (e.g., in B15 or B14).

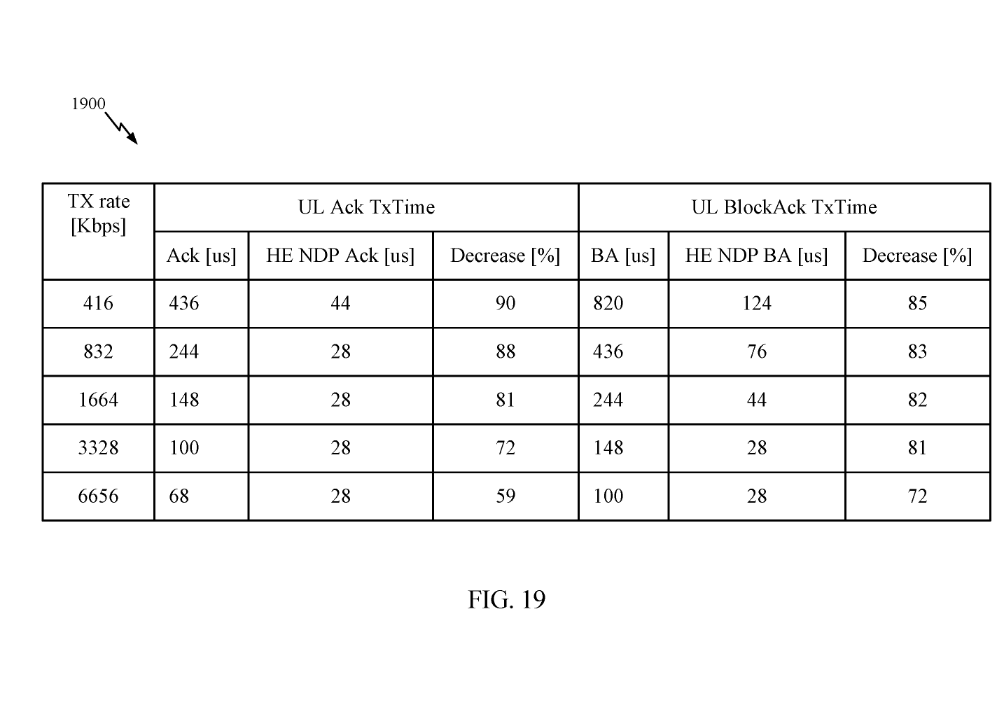

FIG. 19 illustrates a table 1900 demonstrating example performance achievable using compressed response frames, in accordance with certain aspects of the present disclosure.

As illustrated in FIG. 19, use of the compressed response frame NDP format proposed herein may help reduce the overhead of control responses in UL OFDMA by up to 90% in the case of an Ack frame and up to 85% in the case of a BA frame (e.g., assuming an average bitmap size in the NDP frame of 16 bits). NDP control responses may also lead to less interference to neighbor OBSSs.

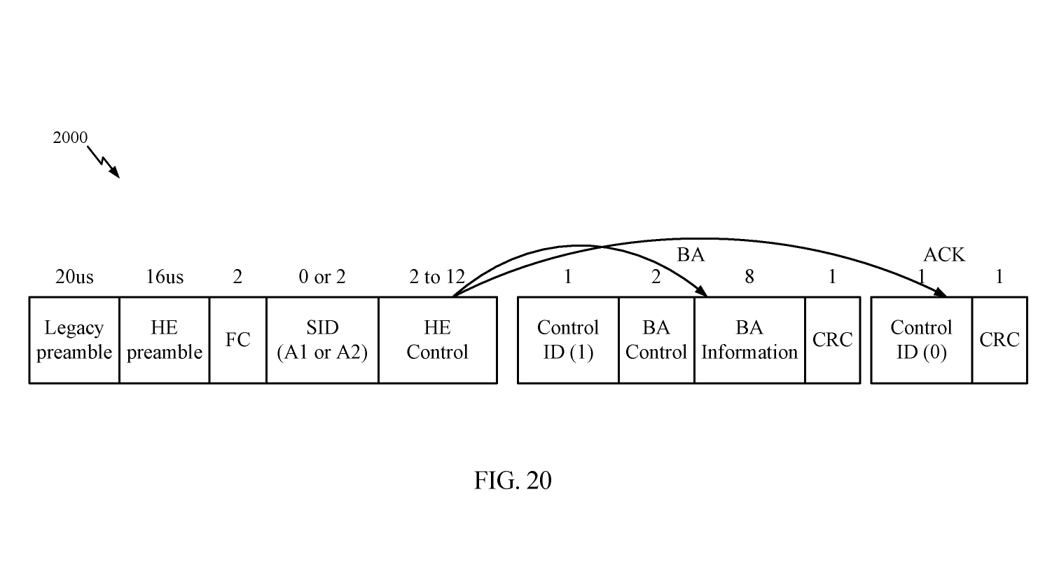

FIG. 20 illustrates an example frame format 2000 with fields of a compressed control field, in accordance with certain aspects of the present disclosure. As illustrated, in the event that the intended receiver of a DL MU PPDU with Aggregation bit equal to 0, the intended receiver may responds with a PV1 HE Control frame that carries Ack/BA information depending on what is being solicited. In this example, neither the SID nor the FCS fields are present in the PV1 HE Control frame. While not included in the response frame, the SID, identifier of the eliciting frame (same as STACK frames), may be used for calculating the CRC. In this example, the FCS is not included, as the CRC field itself may be sufficient to protect the fields up to and including the FC field.

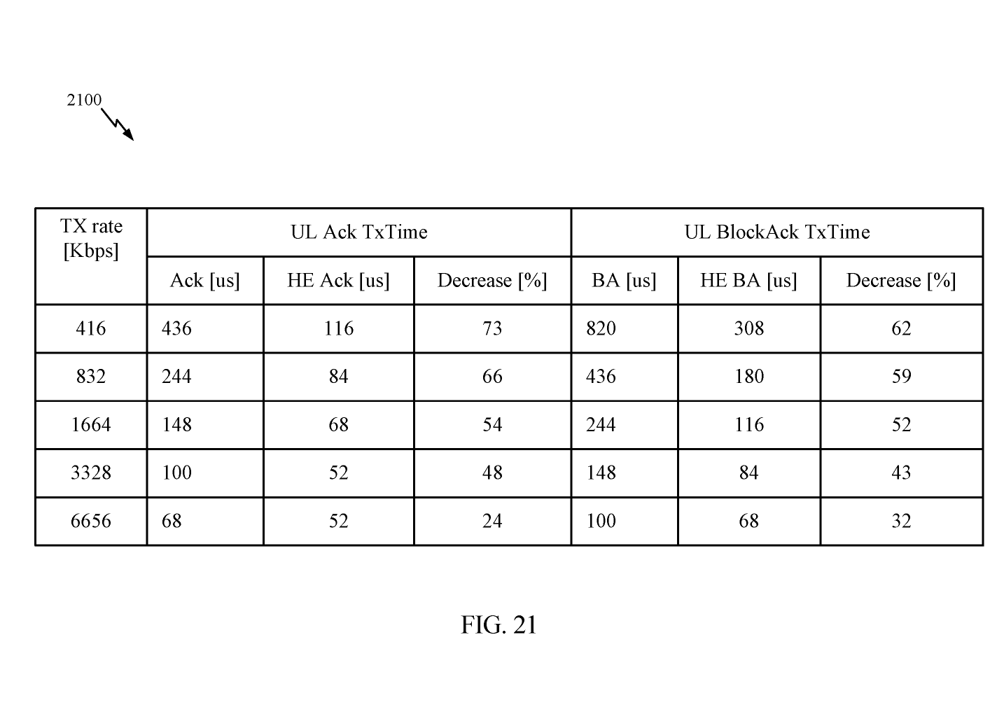

FIG. 21 illustrates a table 2100 demonstrating example performance achievable using compressed response frames, in accordance with certain aspects of the present disclosure.

As illustrated in FIG. 21, use of the compressed response frame format proposed herein may help reduce the overhead of control responses in UL OFDMA by up to 73% in the case of an Ack frame (e.g., with MAC payload reduced by 16 Bytes) and up to 62% in the case of a BA frame (e.g., with MAC payload reduced by 26 Bytes). As noted above, shorter control responses may also lead to less interference to neighbor OBSSs.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 1000 illustrated in FIG. 10 and operations 1100 illustrated in FIG. 11 correspond to means 1000A illustrated in FIG. 10A and means 1100A illustrated in FIG. 11A, respectively.

For example, means for receiving may comprise a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2. Means for transmitting may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2.

Means for processing, means for generating, means for obtaining, means for including, means for selecting, means for outputting, may comprise a processing system, which may include one or more processors, such as the RX data processor 270, the TX data processor 288, and/or the controller 280 of the user terminal illustrated in FIG. 2 or the TX data processor 210, RX data processor 242, and/or the controller 230 of the access terminal 210 illustrated in FIG. 2.

According to certain aspects, such means may be implemented by processing systems configured to perform the corresponding functions by implementing various algorithms (e.g., in hardware or by executing software instructions) described above for providing an immediate response indication in a PHY header. For example, an algorithm for generating a frame based on a compressed frame format, an algorithm for including control information in at least one field of the frame that is not specified in the compressed frame format, and an algorithm for outputting the frame for transmission. In another example, an algorithm for generating a frame having a first one or more bits indicating whether the frame has a compressed format and a second one or more bits indicating which of one or more fields are absent if the frame has a compressed format and an algorithm for outputting the frame for transmission.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for generating a first frame having a PHY header and a MAC payload, instructions for providing an indication in the PHY header of the first frame, that a response frame to the first frame is to be sent within a time period, and instructions for outputting the first frame for transmission. In another example, instructions for obtaining a first frame having a PHY header and a MAC payload and instructions for determining, based on an indication provided in the PHY header of the first frame, that a response frame to the first frame is to be sent within a time period.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a station, comprising:
receiving a frame;
selecting, from a plurality of possible frame formats, a compressed frame format for a response frame to be transmitted in response to the frame, the compressed frame format lacking one or more fields defined by one or more other of the possible frame formats;
generating the response frame based on the compressed frame format; and
outputting the response frame for transmission.

2. The method of claim 1, wherein the selection of the compressed frame format is at least one of:
based on a value of an aggregation bit provided in the frame; or
indicated by the value of the aggregation bit provided in the response frame.

3. The method of claim 2, wherein the value of the aggregation bit determines a format of all frames exchanged with the station within a current transmit opportunity (TXOP).

4. The method of claim 1, wherein the selection of the compressed frame format is indicated by a value of an aggregation bit provided in a signal (SIG) field of the response frame.

5. The method of claim 1, wherein the response frame comprises a high efficiency (HE) control field.

6. The method of claim 5, wherein the HE control field has a control ID field carried in a frame control field.

7. The method of claim 6, wherein a value of the control ID field indicates a type of acknowledgement provided via the frame control field.

8. The method of claim 1, wherein the compressed frame format lacks a service field.

9. The method of claim 8, wherein generating the response frame comprises generating a frame control field based, at least in part, on bits of a service field in the received frame.

10. The method of claim 9, wherein the frame control field is also generated based, at least in part, on bits of a frame control field in the received frame.

11. The method of claim 1, wherein the response frame acknowledges the received frame, with an acknowledgement field or block acknowledgement (BA) field depending on a policy indicated in the received frame.

12. The method of claim 1, wherein generating the response frame comprises:
generating a type of error check value based on at least one field not included in the response frame when output for transmission.

13. The method of claim 12, wherein the at least one field comprises a short identifier (SID) field.

14. The method of claim 1, wherein the frame comprises a multi-user (MU) frame.

15. The method of claim 1, wherein the selection of the compressed frame format is based on a value of an aggregation bit provided in a service (SVC) field of the frame.

16. A method for wireless communications by an apparatus, comprising:
outputting a frame for transmission;
obtaining a response frame transmitted from at least one recipient in response to the frame, the response frame having a compressed frame format, selected from a plurality of possible frame formats, the compressed frame format lacking one or more fields defined by one or more other of the possible frame formats; and
processing the response frame based on the compressed frame format.

17. The method of claim 16, wherein the frame comprises a multi-user (MU) frame.

18. The method of claim 16, wherein the selection of the compressed frame format is at least one of:
indicated by a value of an aggregation bit provided in at least one of the frame; or
based on the value of the aggregation bit provided in the response frame.

19. The method of claim 18, wherein the apparatus is configured to provide different values of the aggregation bit to different recipients of the frame.

20. The method of claim 18, wherein the value of the aggregation bit determines a format of all frames exchanged with the station within a current transmit opportunity (TXOP).

21. The method of claim 18, further comprising providing an aggregation bit in a service (SVC) field of the frame, wherein the selection of the compressed frame format is based on a value of the aggregation bit.

22. An apparatus for wireless communications, comprising:
a memory; and
a processor coupled with the memory and configured to:
receive a frame,
select, from a plurality of possible frame formats, a compressed frame format for a response frame to be transmitted in response to the frame, the compressed frame format lacking one or more fields defined by one or more other of the possible frame formats,
generate the response frame based on the compressed frame format, and
output the response frame for transmission.

23. The apparatus of claim 22, wherein the selection of the compressed frame format is at least one of:
based on a value of an aggregation bit provided in the frame; or
indicated by the value of the aggregation bit provided in the response frame.

24. The apparatus of claim 23, wherein the value of the aggregation bit determines a format of all frames exchanged with the station within a current transmit opportunity (TXOP).

25. The apparatus of claim 22, wherein the selection of the compressed frame format is indicated by a value of an aggregation bit provided in a signal (SIG) field of the response frame.

26. The apparatus of claim 22, wherein the response frame comprises a high efficiency (HE) control field.

27. The apparatus of claim 26, wherein the HE control field has a control ID field carried in a frame control field.

28. The apparatus of claim 27, wherein a value of the control ID field indicates a type of acknowledgement provided via the frame control field.

29. An apparatus for wireless communications, comprising:
a memory; and
a processor coupled with the memory and configured to:
output a frame for transmission,
obtain a response frame transmitted from at least one recipient in response to the frame, the response frame having a compressed frame format, selected from a plurality of possible frame formats, the compressed frame format lacking one or more fields defined by one or more other of the possible frame formats, and
process the response frame based on the compressed frame format.

30. The apparatus of claim 29, wherein the selection of the compressed frame format is at least one of:
indicated by a value of an aggregation bit provided in at least one of the frame; or
based on the value of the aggregation bit provided in the response frame.
